(19) United States
(12) Patent Application Publication
(10) Pub. No.: US 2016/0156563 A1
(43) Pub. Date: Jun. 2, 2016

(54) Network Assisted Rate Adaptation

(71) Applicant: TELEFONAKTIEBOLAGET L M ERICSSON (PUBL), Stockholm (SE)

(72) Inventors: Ylva Timner, Luleå (SE); Jonas Pettersson, Luleå (SE)

(21) Appl. No.: 14/903,689

(22) PCT Filed: Aug. 21, 2013
(86) PCT No.: PCT/SE2013/050983

§ 371 Date: Jan. 8, 2016

(51) Int. Cl. H04L 12/825; H04W 28/02

(52) U.S. Cl. CPC H04L 47/25; H04W 28/0289

(57) ABSTRACT

A network assisted rate adaptor (18) includes a rate controller (14) configured to determine a target rate based on at least one load measure of a radio cell obtained from a scheduler (12), and a rate enforcer (16) configured to enforce the target rate between a data source and a data destination over a shared radio link (10) in the radio cell.

### TECHNICAL FIELD

The proposed technology relates to network assisted rate adaptation.

### BACKGROUND

Rate adaptation for adaptive services with delay requirements in a radio cellular network is difficult. The sending rate is controlled by the end-points, but the end-points have very little knowledge of the network load and capacity. When the transmission is delay critical it can then be fatal to select a rate that is too high and cause congestion. Also, a too conservative adaptation algorithm will give the client lower service quality than necessary. If the service is prioritized in the scheduler, in order to fulfill delay requirements, the end-points will not be able to detect congestion, and high rates will be used even if the network is congested.

Rate adaptation is normally done in the end-points. There are different ways to detect congestion and estimate the bandwidth, but all end-point algorithms are based on measurements on transmitted packets and some kind of feedback being transmitted between the receiver and sender. A major problem with end-point based adaptation is that only a very limited amount of information is available at the end-points. Also, if the service is prioritized in the scheduler, it will not be possible for the end-points to detect congestion for the non-prioritized traffic.

A different kind of existing technology is network assisted rate adaptation performed in a node without accurate knowledge about the instantaneous load in the schedulers which control the shared radio links. Examples are given in the following references:

British Telecom: “Data rate control” [1]—Congestion based pricing is used. The price per rate is signaled to the end-points, and the end-points selects a rate based on congestion level and what the client is prepared to pay. A drawback is that the price accepted by the client must be known, and the network will not be able to control the network load fast enough resolve a congestion situation before the time-out of conversational traffic.

Qualcomm: “Managing video adaptation algorithms” [2]—Adaptation parameters like thresholds and filter parameters are selected in the network and signaled to the end-points. A drawback of this solution is that the end-point algorithms must be strictly standardized and the adaptation parameters are not updated fast enough to resolve a congestion situation before the time-out of conversational traffic.

Azuki systems: “Method and system for efficient streaming video dynamic rate adaptation” [3]—A streaming server in the network monitors network load. During congestion transcoding is used to limit the video bitrates. The algorithm is only estimating bandwidth based on measurement on the transmitted packets and hence acts like an end-point algorithm.

RIM: “ECN based rate adaptation using binary markings in communication systems” [4]—ECN (Explicit Congestion Notification) markings are used to inform the end-points of network congestion. No method for actually detecting congestion is described, only how the end-points should react on congestion notifications. The method is fast enough to help the end-points keep the delay requirements, but the exact meaning of the ECN-marking should be standardized in order to aid the end-points in the rate selection. Also with ECN it is only possible to signal when the end-point should decrease the rate. The method will not help the end-points to know when the congestion situation is resolved and the rate can be increased.

RIM: “System and method for network congestion control” [5]—Congestion control is done in two steps, first rate adaptation and then traditional CC (drop/block bearers). Rate adaptation is done through congestion notifications embedded in the packets (like ECN), The drawbacks are the same as for the previous reference. Congestion is only described in terms of a “congestion level of at least one network node of the network is greater than a first/second threshold”.

DoCoMo Eurolabs have done work on rate adaptation controlled from a centralized QoE (Quality of Experience) box [6]. A drawback with this approach is that it assumes that the congestion of the shared radio link can be estimated from knowing the channel quality and bit rate of the adapted clients alone.

### SUMMARY

An object of the proposed technology is to overcome at least one of the above stated drawbacks.

This and other objects are met by embodiments of the proposed technology.

An aspect of the proposed technology relates to a network assisted rate control method. The method determines a target rate based on at least one load measure of a radio cell obtained from a scheduler. The method also sends a control signal representing the determined target rate to a rate enforcer for enforcing the target rate between a data source and a data destination over a shared radio link in the radio cell

Another aspect of the proposed technology relates to a network assisted rate enforcement method. The method includes the step of receiving a control signal representing a target rate that is based on at least one load measure of a radio cell obtained from a scheduler. The method also enforces the target rate between a data source and a data destination over a shared radio link in the radio cell.

Another aspect of the proposed technology relates to a network assisted rate adaptation method. The method determines a target rate based on at least one load measure of a radio cell obtained from a scheduler. The method also enforces the target rate between a data source and a data destination over a shared radio link in the radio cell.

Another aspect of the proposed technology relates to a rate controller. The rate controller includes a rate estimator configured to determine a target rate based on at least one load measure of a radio cell obtained from a scheduler. The rate controller also includes a communication unit configured to send a control signal representing the determined target rate to a rate enforcer for enforcing the target rate between a data source and a data destination over a shared radio link in the radio cell.

Another aspect of the proposed technology relates to a base station having a rate controller. The rate controller includes a rate estimator configured to determine a target rate based on at least one load measure of a radio cell obtained from a scheduler. The rate controller also includes a communication unit configured to send a control signal representing the determined target rate to a rate enforcer for enforcing the target rate between a data source and a data destination over a shared radio link in the radio cell.

Another aspect of the proposed technology relates to a rate estimator configured to determine a target rate based on at least one load measure of a radio cell obtained from a scheduler.

Another aspect of the proposed technology relates to a rate enforcer configured to receive a control signal representing a target rate that is based on at least one load measure of a radio cell obtained from a scheduler, and to enforce the target rate between a data source and a data destination over a shared radio link in the radio cell.

Another aspect of the proposed technology relates to a data source network node including a rate enforcer configured to receive a control signal representing a target rate that is based on at least one load measure of a radio cell obtained from a scheduler, and to enforce the target rate from the data source network node to a data destination over a shared radio link in the radio cell.

Another aspect of the proposed technology relates to a base station having a network assisted rate adaptor. The rate adaptor includes a rate controller configured to determine a target rate based on at least one load measure of a radio cell obtained from a scheduler. The rate adaptor also includes a rate enforcer configured to enforce the target rate between a data source and a data destination over a shared radio link in the radio cell.

Another aspect of the proposed technology relates to a computer program for rate estimation. The computer program comprise computer readable code units which when run on a computer causes the computer to determine a target rate based on at least one load measure of a radio cell obtained from a scheduler.

Another aspect of the proposed technology relates to a computer program product, comprising computer readable medium and a computer program stored on the computer readable medium. The computer program comprises computer readable code units which when run on a computer causes the computer to determine a target rate based on at least one load measure of a radio cell obtained from a scheduler.

An advantage of the proposed technology is that it can maintain low delay and high encoding rates, such as video encoding rates, while a fair amount of radio resources still are available for other services in the system.

### BRIEF DESCRIPTION OF THE DRAWINGS

The proposed technology, together with further objects and advantages thereof, may best be understood by making reference to the following description taken together with the accompanying drawings, in which:

FIG. 1 is a block diagram illustrating network assisted rate adaptation in accordance with the proposed technology;

FIG. 2 is a block diagram illustrating network assisted rate adaptation in accordance with an example embodiment of the proposed technology;

FIG. 3 is a block diagram illustrating network assisted rate adaptation in accordance with another example embodiment of the proposed technology;

FIG. 4 is a block diagram illustrating network assisted rate adaptation in accordance with a further example embodiment of the proposed technology;

FIG. 5 is a flow chart illustrating a network assisted rate adaptation method in accordance with the proposed technology;

FIG. 6 is a flow chart illustrating a network assisted rate control method in accordance with the proposed technology;

FIG. 7 is a flow chart illustrating a network assisted rate enforcement method in accordance with the proposed technology;

FIG. 8 is a block diagram of an example embodiment of a rate controller in accordance with the proposed technology;

FIG. 9 is a block diagram of an example embodiment of a rate enforcer in accordance with the proposed technology;

FIG. 10 is a block diagram of an example embodiment of a rate estimator in accordance with the proposed technology;

FIG. 11 is a block diagram of an example embodiment of a base station in accordance with the proposed technology;

FIG. 12 is a block diagram of an example embodiment of a data source network node in accordance with the proposed technology; and

FIG. 13 is a block diagram of an example embodiment of a base station in accordance with the proposed technology.

### DETAILED DESCRIPTION

The proposed technology is based on the insight that to decide target rates in the network without taking the scheduler load into account makes it difficult to make good decisions, since it is only the scheduler that has the full picture of the congestion situation.

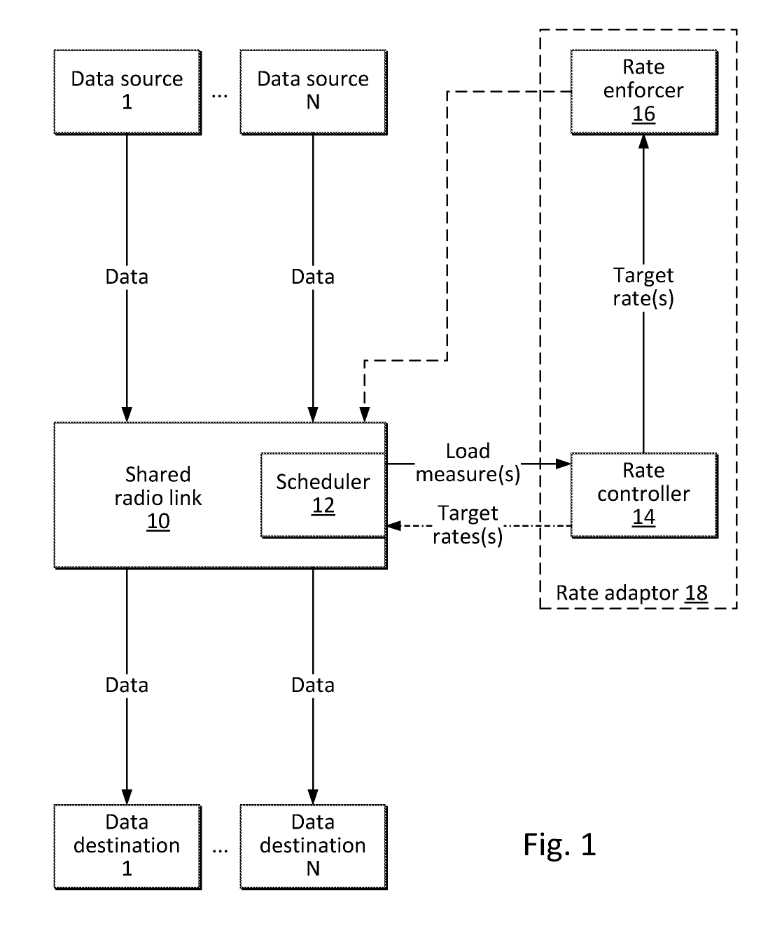

The general concept of the proposed technology is illustrated in FIG. 1. A scheduler 12 schedules data that is transmitted over a shared radio link 10. Several data flows from data sources 1 . . . N carrying different services are using this shared radio link to transport packets to corresponding N data destinations. Load measurements from the scheduler 12 are used by a rate adaptor 18 to determine and enforce target rates for the services.

On this general level the network assisted rate adaptor 18 includes
a rate controller 14 configured to determine a target rate based on at least one load measure of a radio cell obtained from a scheduler 12
a rate enforcer 16 configured to enforce the target rate between a data source and a data destination over a shared radio link 10 in the radio cell.

A target rate is determined in the rate controller 14 based on information available in the scheduler 12, for example: number of adaptive clients (clients capable of externally controllable send rate adaptation), total number of clients, radio resource utilization and/or scheduling weights used. The target rate is then enforced by the rate enforcer 16, either by signaling the target rate to the respective data source, or is enforced in the network itself. The rate could, for example, be enforced through policing, transcoding, buffering and/or ECN. The different rate enforcement approaches have been indicated as a dashed control line between the rate enforcer 16 and the shared radio link 10. The target rate may also be fed back the scheduler 12, so that it can act differently depending on the expected rate of incoming data, as shown by the dash-dot line from the rate controller 14 to the scheduler 12.

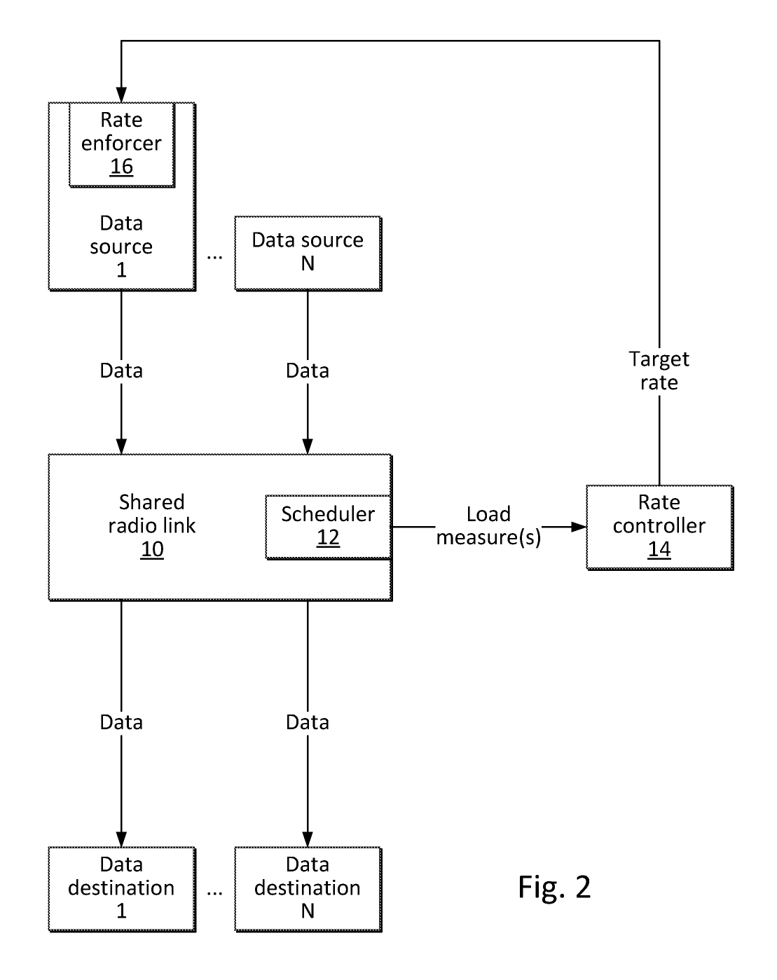

As mentioned above, in one embodiment the target rate can be signaled directly to the data source. This can be described as the rate enforcer 16 being located at the data source, as illustrated by data source 1 in FIG. 2. Thus, this embodiment assumes that the client represented by the data source receiving the target rate is capable of externally controllable send rate adaptation. Examples of clients having such capability were discussed in the background (end-point algorithms). For example, a typical video client sends messages describing reception quality, and the sender adapts it bitrate based on such messages. According to the proposed technology the target rate may, for example, be signaled on a dedicated channel or by using the RTP Control Protocol (RTCP), a sister protocol to the Real-time Transport Protocol (RTP).

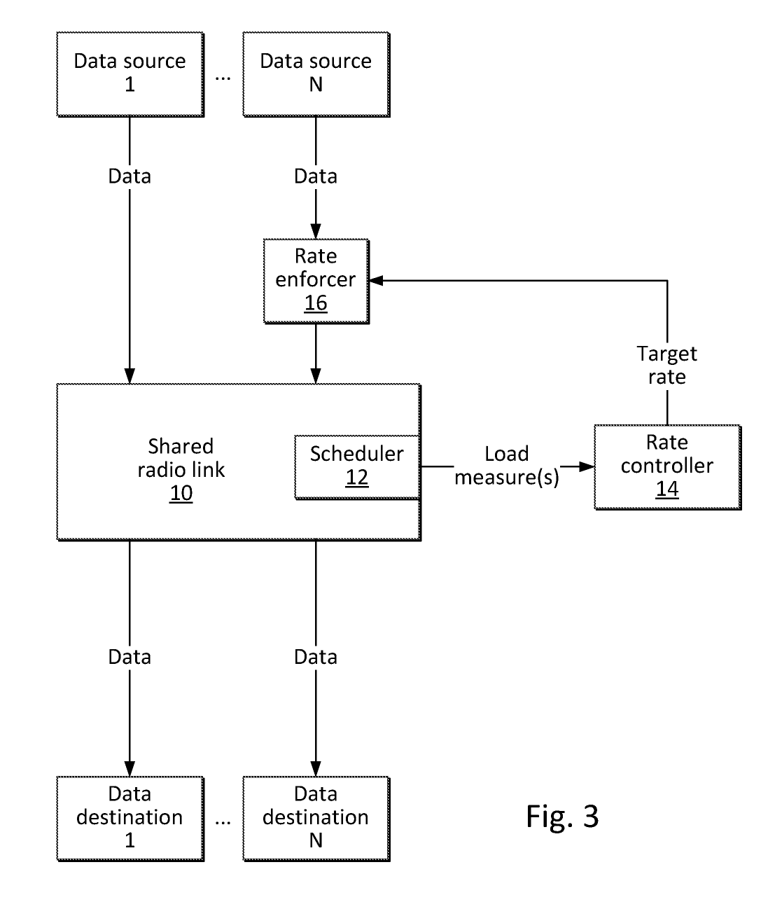

In another embodiment there can be a rate enforcer 16 in the data path (as illustrated in FIG. 3) that enforces the rate by dropping or marking packets. The rate enforcer may, for example, be implemented in a base station, router or gateway, for example a packet data network gateway in LTE (Long-Term Evolution) core.

Different alternatives can be used for different clients in the same system, depending on whether the data sources have rate enforcers implemented (are capable of externally controllable send rate adaptation) or not.

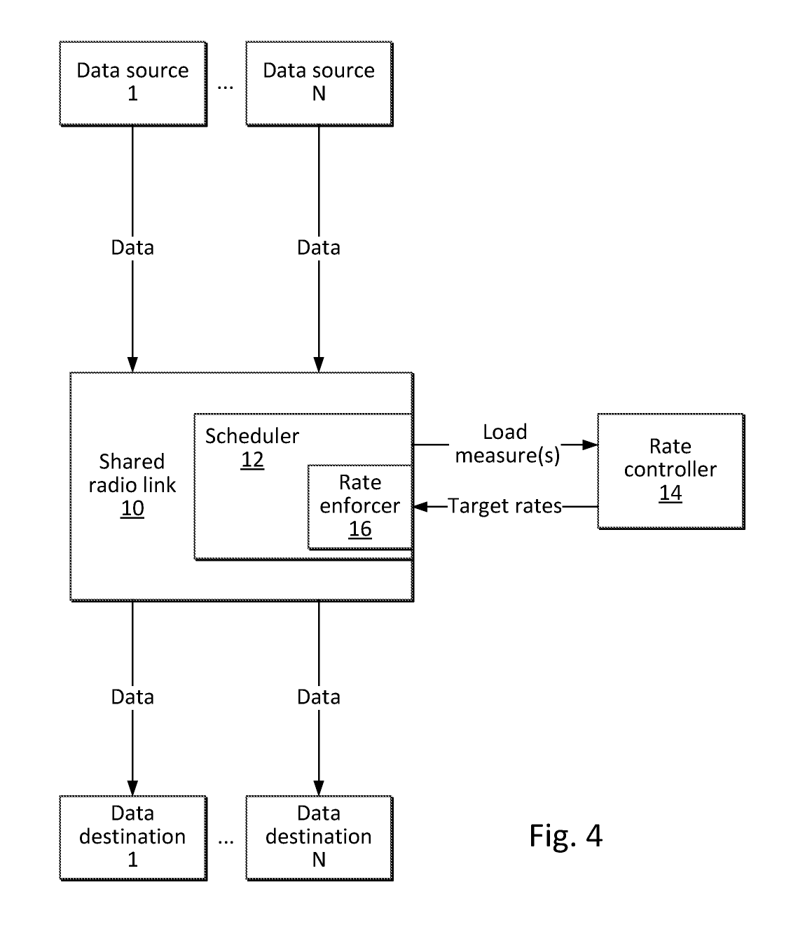

As illustrated in FIG. 4, the rate enforcer 16 may also be placed in the scheduler 12, so that the target rates are enforced through the scheduling decisions.

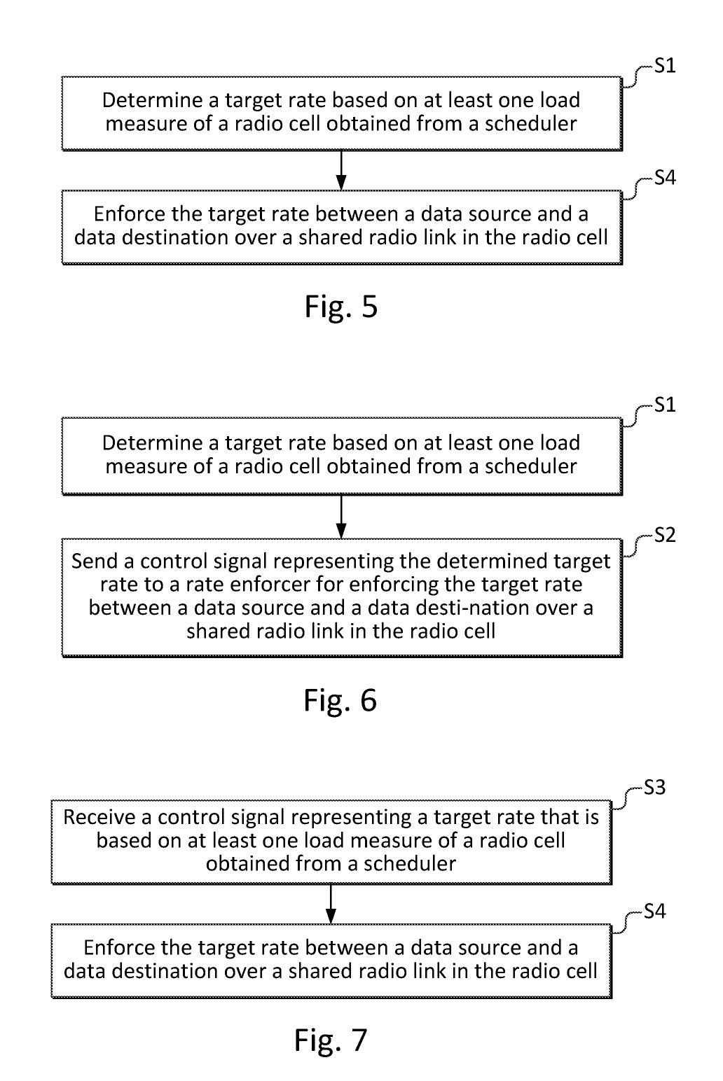

The general proposed network assisted rate adaptation method is illustrated in FIG. 5. Step S1 determines a target rate based on at least one load measure of a radio cell obtained from a scheduler. Step S4 enforces the target rate between a data source and a data destination over a shared radio link in the radio cell.

When the functionality of the rate adaptation is distributed, for example as illustrated in FIGS. 2, 3 and 4, the rate determining step S1 and the rate enforcing step S4 are performed in different entities, and the target rate is communicated between these entities. This is illustrated by the embodiments of FIGS. 6 and 7.

The embodiment of FIG. 6 illustrates a first part of this distributed embodiment, namely a network assisted rate control method. Step S1 determines a target rate based on at least one load measure of a radio cell obtained from a scheduler. Step S2 sends a control signal representing the determined target rate to a rate enforcer for enforcing the target rate between a data source and a data destination over a shared radio link in the radio cell.

In one embodiment, for example as illustrated in FIG. 2, the control signal is sent to the data source for adapting the rate from the data source to the target rate.

In another embodiment, for example as illustrated in FIG. 3, the control signal is sent to a network node in a path between the data source and the data destination for adapting, in the network node, the rate from the data source to the target rate.

The embodiment of FIG. 7 illustrates a second part of the distributed embodiment, namely a network assisted rate enforcement method. Step S3 receives a control signal representing a target rate that is based on at least one load measure of a radio cell obtained from a scheduler. Step S4 enforces the target rate between a data source and a data destination over a shared radio link in the radio cell.

In one embodiment, for example as illustrated in FIG. 2, the control signal representing the target rate is received in the data source. The rate from the data source is then adapted to the target rate.

In one embodiment, for example as illustrated in FIG. 3, the control signal representing the target rate is received in a network node in a path between the data source and the data destination. The rate from the data source is adapted, in the network node, to the target rate using buffering, Explicit Congestion Notification, Active Queue Management or transcoding of media.

In one embodiment, for example as illustrated in FIG. 4, the target rate is enforced through scheduling decisions.

In one embodiment the target rate is signaled to the scheduler, as illustrated with a dash-dotted line in FIG. 1, and used in scheduling decisions.

In one embodiment packets are prioritized during scheduling as long as the resulting rate is below the target rate plus a predetermined offset. This offset may be positive, negative or zero, depending on the relationship between the current rate and the target rate. Different offsets from the average rate may be desirable for different distributions.

In one embodiment packet delay is estimated during scheduling based on the target rate and a measure representing scheduler buffer fill level. This measure may be an estimated or a reported measure.

As noted above, rate adaptation may be based on different load measures. For example, load measure(s) may be selected among:
the number of clients in the radio cell capable of externally controllable send rate adaptation
the number of clients in the radio cell incapable of externally controllable send rate adaptation and having data in the scheduled buffer
the total radio resource utilization in the radio cell
the radio resources used by clients in the radio cell capable of externally controllable send rate adaptation
the amount of radio resources that are scheduled with scheduling priority within a predetermined range
the amount of radio resources that are scheduled when a predetermined delay threshold of the data is exceeded.

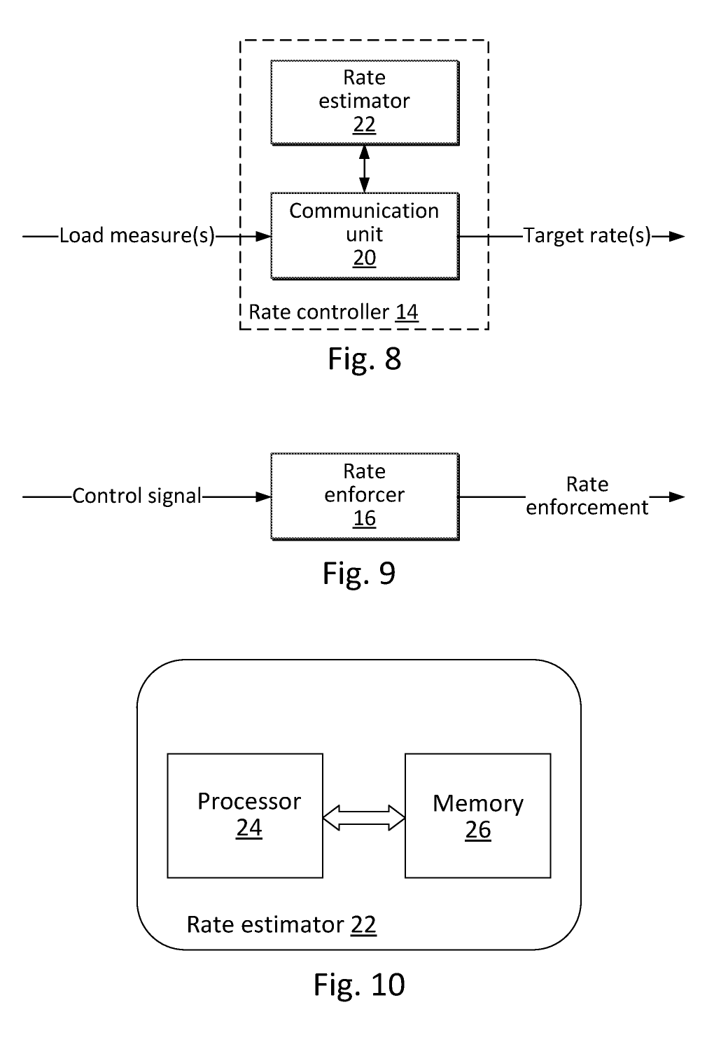

FIG. 8 is a block diagram of an example embodiment of a rate controller in accordance with the proposed technology. The rate controller 14 includes a rate estimator 22 configured to determine a target rate based on at least one load measure of a radio cell obtained from a scheduler, and a communication unit 20 configured to send a control signal representing the determined target rate to a rate enforcer for enforcing the target rate between a data source and a data destination over a shared radio link in the radio cell. Typically the load measures are continuously received by the communication unit 20 and forwarded to the rate estimator 22. The estimated rate is then forwarded back to the communication unit 20, which sends a corresponding control signal to the rate enforcer.

FIG. 9 is a block diagram of an example embodiment of a rate enforcer in accordance with the proposed technology. The rate enforcer 16 is configured to receive a control signal representing a target rate that is based on at least one load measure of a radio cell obtained from a scheduler, and to enforce the target rate between a data source and a data destination over a shared radio link in the radio cell. The rate enforcement may be accomplished as described above.

FIG. 10 is a block diagram of an example embodiment of a rate estimator 22 in accordance with the proposed technology. The rate estimator 22 is configured to determine a target rate based on at least one load measure of a radio cell obtained from a scheduler. In one embodiment the rate estimator 22 comprises a processor 24 and memory 26. The memory 26 contains instructions executable by the processor 24, whereby the rate estimator 22 is operative to determine a target rate based on at least one load measure of a radio cell obtained from a scheduler.

One aspect of the proposed technology is a computer program for rate estimation. The computer program comprises computer readable code units which when run on a computer causes the computer to determine a target rate based on at least one load measure of a radio cell obtained from a scheduler.

One aspect of the proposed technology is a computer program product, comprising computer readable medium and a computer program stored on the computer readable medium, said computer program comprising computer readable code units which when run on a computer causes the computer to determine a target rate based on at least one load measure of a radio cell obtained from a scheduler.

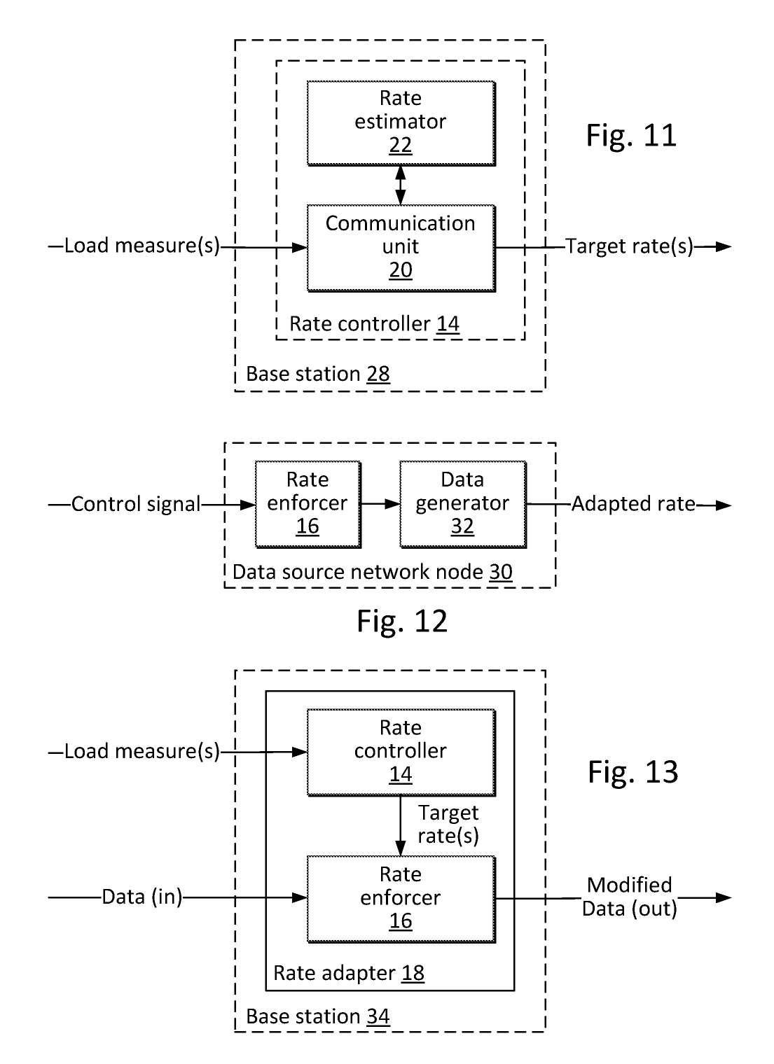

FIG. 11 is a block diagram of an example embodiment of a base station 28 in accordance with the proposed technology. 2. The base station 28 has a rate controller 14 that includes a rate estimator 22 configured to determine a target rate based on at least one load measure of a radio cell obtained from a scheduler. The rate controller 14 further includes a communication unit 20 configured to send a control signal representing the determined target rate to a rate enforcer for enforcing the target rate between a data source and a data destination over a shared radio link in the radio cell.

FIG. 12 is a block diagram of an example embodiment of a data source network node in accordance with the proposed technology. The data source network node 30 includes a rate enforcer 16 configured to receive a control signal representing a target rate that is based on at least one load measure of a radio cell obtained from a scheduler, and to enforce the target rate from the data source network node 30 to a data destination over a shared radio link in the radio cell. The rate enforcement may, for example be accomplished by selecting a corresponding encoding mode of a data generator 34. In another embodiment the order between the rate enforcer 16 and data generator 34 may be reversed. In such a case the target rate may be enforced, for example, by dropping or delaying generated data. The data source network node 30 may, for example, be a User Equipment (UE) or a computer. Examples of UEs are smartphones and tablets.

FIG. 13 is a block diagram of an example embodiment of a base station in accordance with the proposed technology. The base station 34 has a network assisted rate adaptor 18. The rate adaptor includes a rate controller 14 configured to determine a target rate based on at least one load measure of a radio cell obtained from a scheduler. The rate adaptor also includes a rate enforcer 16 configured to enforce the target rate between a data source and a data destination over a shared radio link in the radio cell. In this embodiment the base station does not only determine target rates, it also enforces them. This type of base station may thus be provided between the data sources and the radio link to adapt the rate of incoming data to the target rates. The rate enforcement may be performed by modification of the outgoing data. The modification may be an explicit rate reduction by transcoding of incoming data. Another example is to discard packets, thereby forcing the data source to reduce its output rate. Another example is to simply modify the outgoing data by setting the ECN bits, which will implicitly result in a data rate reduction from the data source.

Having described the general principles of the proposed technology, two specific rate adaptation examples will be described below with reference to a shared LTE radio link and a conversational video service, namely:
Rate fair adaptation
Radio resource fair adaptation

In this context the data sources and data destinations are video clients and the shared radio link is an LTE shared channel.

### Rate Fair Adaptation

With the rate fair rate adaptation, all video clients in the radio cell are allowed to use the same video rate. This should result in good client fairness, and the signaling and computational load should be reasonably low, since only one rate value per radio cell is computed and signaled to upper layers. A potential drawback of this approach is that large amounts of radio resources may be spent in order to give clients with bad coverage the same bit rate as other clients in the radio cell.

### Adaptation Based on Number of Clients

The recommended bit rate is updated based on the traffic load as well as the number of adaptive video clients in the radio cell. When a client arrives or leaves the radio cell, a new bit rate is calculated in accordance with:

Rate_{new}=Rate_{old}*N_{old}/N_{new} (1)

where N is the number of adaptive video clients and Rate is the recommended video rate.

### Radio Resource Utilization Measurement

The radio cell traffic load is estimated by two radio resource utilization measures, CU_{highPrio} and CUₚᵣᵢₒ. CU_{highPrio} is the fraction of radio resources that are scheduled with high priority, that is, radio resources used for delay critical video packets and retransmissions. CUₚᵣᵢₒ is the fraction of radio resources that are scheduled with the same and higher priority than video packets that are not delay critical (in many cases this is the same as the total radio resource utilization). New utilization values may, for example, be calculated every 100 ms as an average of the utilization in each time slot.

Queue Compensation If the radio resource utilization is 100%, there might be many packets in queue, and the actual radio cell load might be significantly higher than 100%. In order to compensate for that, the utilization may be increased by a queue compensation factor if it is close to 100%, for example in accordance with:

if CU>QueueThreshold: CU=CU*QueueCompensationFactor (2)

where QueueThreshold is close to 1, and QueueCompensationFactor could be a static value larger than 1. Simulations have shown good results with a QueueThreshold of 0.99 and a QueueCompensationFactor of 1.5.

Adaptation Based on Radio Resource Utilization

When new radio resource utilization measures are calculated, the recommended rate is adapted based on the new values. Two radio resource utilization targets, T_{highPrio} and Tₚᵣᵢₒ are used, one for each radio resource utilization measure. If CU_{highPrio} is above the target, the rate is adapted in accordance with:

Rate_{new}=Rate_{old}*(1+a_{highPrio}*(T_{highPrio}/CU_{highPrio}−1)) (3)

where a_{highPrio} is 1 or lower, and T_{highPrio} may be in the range 20-50%. If CU_{highPrio} is below the target, the rate is adapted based on CUₚᵣᵢₒ in accordance with:

Rate_{new}=Rate_{old}*(1+aₚᵣᵢₒ*(Tₚᵣᵢₒ/CUₚᵣᵢₒ−1)) (4)

where aₚᵣᵢₒ is below 1, and Tₚᵣᵢₒ is 100% or lower. Simulations have shown good results when a_{highPrio} is 1, aₚᵣᵢₒ is 0.3, T_{highPrio} is 30% and Tₚᵣᵢₒ is 100%.

This use of two sets of filter parameters results in an asymmetrical filter. The rate will be increased slowly when CUₚᵣᵢₒ is below the target, but if the amount of delay critical packets is high, and CU_{highPrio} is above the target, the rate will be decreased rapidly in order to keep the client delays at acceptable levels.

### Radio Resource Fair Adaptation

The adaptation principle that is used for the radio resource fair network-assisted rate adaptation is that all clients, regardless of service, should get an equal share of the radio resources. This is similar to the principle that is used in a proportionally fair scheduler, but in the present case it is applied to rate adaptation instead of scheduling.

The central part is an open loop regulator, which determines appropriate video bitrates based on the measured number of active clients in the radio cell and the reported channel quality (represented by the channel quality indicator, CQI) of each video client. First a target utilization per client u* is calculated. In the basic case this is just an equal split of the radio resources in accordance with:

$${u}^{*} = \frac{1}{{N}_{video} + {N}_{other}} , \qquad ( 5 )$$

where N_{video} is the number of clients in the radio cell capable of externally controllable send rate adaptation and Nₒₜₕₑᵣ is the number of clients in the radio cell incapable of externally controllable send rate adaptation and having data in the scheduled buffer. The latter may change very rapidly and is therefore filtered with an exponentially weighted moving average (EWMA) filter.

The target video bitrate R*ᵢ for client i is then determined based on the channel quality: The reported CQI from the UE is transformed into an estimated maximum bitrate Qᵢ that a client with the reported CQI would get if the CQI were correct and all radio resources were assigned to that client. As shown in Equation (6) below, the target rate that would result in the target utilization is simply the target utilization multiplied by this maximum bit rate.

$${u}_{i} = \frac{{R}_{i}}{{Q}_{i}} ⇒ {R}_{i}^{*} = {u}_{i}^{*} {Q}_{i} \qquad ( 6 )$$

The estimated maximum bit rate may also be filtered with an EWMA filter to get smoother rate changes.

### Closing the Loop

To make the algorithm more robust a closed loop component may be added. This is done by multiplying the desired rate by a correction factor 1+γ, as in Equation (7) below, and then regulate γ to minimize the error between the expected utilization U*_{video} and the actual utilization Û_{video}, i.e. the radio resources used by clients in the radio cell capable of externally controllable send rate adaptation, as shown in Equations (8)-(10) below:

$$\begin{matrix}{R}_{i}^{*} = {u}^{*} {Q}_{i} ( 1 + γ ) & ( 7 ) \\ {U}_{video}^{*} = \frac{{N}_{video}}{{N}_{video} + {N}_{other}} & ( 8 ) \\ e = {U}_{video}^{*} - {\hat{U}}_{video} & ( 9 ) \\ {γ}_{k} = {γ}_{k - 1} + {K}_{P} [ ( 1 + \frac{Δ }{T} ) {e}_{k} - {e}_{k - 1} ] & ( 10 )\end{matrix}$$

where Kₚ is the proportional gain of the controller, for example 0.7, Δ is the sampling time, for example 1 ms, and Tᵢ is the integral time of the controller, for example 0.5 s.

Equation (10) is a discrete proportional-integral controller. When the minimum and maximum video rates are known, the expected utilization may be adjusted to take this into account by reversing Equation (7) instead of using the target utilization directly, as shown in Equation (11) below:

$${U}_{video}^{*} = {\sum }_{i} \frac{limit ( {R}_{i}^{*} )}{{Q}_{i} ( 1 + γ )} . \qquad ( 11 )$$

### Adjusted Fairness

The basic equal split of radio resources is not always the desired behavior. In proportionally fair scheduling, the concept of relative priority is used: A client with relative priority ρ will get ρ times the amount of radio resource (and bit rate) as an other client with the same radio conditions and relative priority one. This concept may also be applied to the radio resource fair rate adaptation algorithm, by altering the target utilization equation as in Equation (12) below:

$${u}^{*} = \frac{ρ}{ρ {N}_{video} + {N}_{other}} \qquad ( 12 )$$

Note that this changes how the video clients back off their rate to the number of other clients, but not towards other video clients. If there are only video clients in a radio cell, the relative priority has no impact at all.

A different way to adjust how the target utilization changes with number of clients is to add exponents to N_{video} and Nₒₜₕₑᵣ. By setting exponents larger than one, the video rate is reduced when the number of clients is high. Adding an offset to Nₒₜₕₑᵣ further makes it possible to reduce the video rate, especially at low load, see Equation (13) below:

$${u}^{*} = \frac{1}{{N}_{video}^{a} + {( {N}_{other} + offset )}^{b}} \qquad ( 13 )$$

As previously mentioned, the target rates can also be fed back to the scheduler 12. The scheduler can use the information about target rates to make better scheduling decisions.

One possibility is to give priority to packets belonging to a flow as long as the bit rate for that flow over the shared radio link 10 is below the target rate. This will guarantee radio resources for the rate adapted source up to the provided target rate.

A second possibility is to use knowledge about the target rate to better interpret the buffer status reports from a UE in the uplink. This is done by assuming that the arrival rate to a buffer is the given target rate. Then it is possible to predict the size of a buffer after a buffer status report has arrived:

buffer_size_estimate=reported_size+time_since_report*target_rate (14)

It is also possible to estimate delay of the oldest packet in a buffer by taking the estimated buffer size and dividing that by the target rate:

age_estimate=buffer_size_estimate/target_rate (15)

The age estimate can then be used to do delay based scheduling.

In one embodiment the scheduler gives priority to video packets that have waited a long time in the scheduler.

In one embodiment packet delay can be estimated based on the target bitrate and the buffer fill level (uplink buffer estimation)

In one embodiment the target rate is determined based on the channel quality between the data source and the data destination, in addition to said at least one load measure.

Although many embodiments have been described with reference to the downlink, the same principles may be applied to the uplink as well.

It will be understood by those skilled in the art that various modifications and changes may be made to the proposed technology without departure from the scope thereof, which is defined by the appended claims.

### ABBREVIATIONS

AQM Active Queue Management
CQI Channel Quality Indicator
ECN Explicit Congestion Notification
EWMA Exponentially Weighted Moving Average
LTE Long-Term Evolution
QoE Quality of Experience
RTCP RTP Control Protocol
RTP Real-time Transport Protocol
UE User Equipment

### REFERENCES

1. Peterjan Van Nieuwenhuizen, British Telecom, “Data rate control”, Patent WO2004010643A1
2. Nikolay K. Leung, Qualcomm, “Managing video adaptation algorithms”, US patent US20100316066
3. Kevin J. Ma et al, Azuki Systems Inc., “Method and system for efficient streaming video dynamic rate adaptation”, Patent WO2010111261 A1
4. R. C. Burbidge, Research in Motion Limited, “Explicit congestion notification based rate adaptation using binary marking in communication systems”, Patent WO2011085348A1
5. Xiaoming Zhao et al, Research in Motion Limited, “System and method for network congestion control”, Patent WO2011133816A1
6. Shehada, M., Thakolsri, S., Despotovic, Z., & Kellerer, W. (2011, October). QoE-based Cross-Layer Optimization for video delivery in Long Term Evolution mobile networks. In Wireless Personal Multimedia Communications (WPMC), 2011 14th International Symposium on (pp. 1-5). IEEE.

1-24. (canceled)

25. A network assisted rate control method, the method comprising:
determining a target rate based on at least one load measure of a radio cell obtained from a scheduler;
sending a control signal representing the determined target rate to a rate enforcer for enforcing the target rate between a data source and a data destination over a shared radio link in the radio cell.

26. The method of claim 25, wherein the at least one load measure is selected among the following:
a number of clients in the radio cell capable of externally controllable send rate adaptation;
a number of clients in the radio cell incapable of externally controllable send rate adaptation and having data in the scheduled buffer;
a total radio resource utilization in the radio cell;
radio resources used by clients in the radio cell capable of externally controllable send rate adaptation;
an amount of radio resources that are scheduled with scheduling priority within a predetermined range;
an amount of radio resources that are scheduled when a predetermined delay threshold of the data is exceeded.

27. The method of claim 25, further comprising sending the control signal to the data source for adapting the rate from the data source to the target rate.

28. The method of claim 25, further comprising sending the control signal to a network node in a path between the data source and the data destination for adapting, in the network node, the rate from the data source to the target rate.

29. A network assisted rate enforcement method, the method comprising:
receiving a control signal representing a target rate that is based on at least one load measure of a radio cell obtained from a scheduler;
enforcing the target rate between a data source and a data destination over a shared radio link in the radio cell.

30. The method of claim 29, further comprising:
receiving the control signal representing the target rate in the data source;
adapting the rate from the data source to the target rate.

31. The method of claim 29, further comprising:
receiving the control signal representing the target rate in a network node in a path between the data source and the data destination;
adapting, in the network node, the rate from the data source to the tar-get rate using buffering, Explicit Congestion Notification, Active Queue Management, or transcoding of media.

32. The method of claim 29, further comprising using the target rate in scheduling decisions.

33. The method of claim 32, further comprising prioritizing packets during scheduling as long as the resulting rate is below the target rate plus a predetermined offset.

34. The method of claim 32, further comprising estimating packet delay during scheduling based on the target rate and a measure representing scheduler buffer fill level.

35. A network assisted rate adaptation method, the method comprising:
determining a target rate based on at least one load measure of a radio cell obtained from a scheduler;
enforcing the target rate between a data source and a data destination over a shared radio link in the radio cell.

36. The method of claim 35, wherein the at least one load measure is selected among the following:
a number of clients in the radio cell capable of externally controllable send rate adaptation;
a number of clients in the radio cell incapable of externally controllable send rate adaptation and having data in the scheduled buffer;
a total radio resource utilization in the radio cell;
radio resources used by clients in the radio cell capable of externally controllable send rate adaptation;
an amount of radio resources that are scheduled with scheduling priority within a predetermined range;
an amount of radio resources that are scheduled when a predetermined delay threshold of the data is exceeded.

37. A rate controller, comprising:
a rate estimator circuit configured to determine a target rate based on at least one load measure of a radio cell obtained from a scheduler;
a communication circuit configured to send a control signal representing the determined target rate to a rate enforcer for enforcing the target rate between a data source and a data destination over a shared radio link in the radio cell.

38. A base station, comprising:
a rate controller;
wherein the rate controller comprises:
a rate estimator circuit configured to determine a target rate based on at least one load measure of a radio cell obtained from a scheduler;
a communication circuit configured to send a control signal representing the determined target rate to a rate enforcer for enforcing the tar-get rate between a data source and a data destination over a shared radio link in the radio cell.

39. A rate estimator, comprising:
a processing circuit configured to determine a target rate based on at least one load measure of a radio cell obtained from a scheduler.

40. The rate estimator of claim 39:
further comprising memory containing instructions executable by the processing circuit,
wherein the instructions, when executed by the processing circuit causes the rate estimator to be configured to determine a target rate based on at least one load measure of a radio cell obtained from a scheduler.

41. A rate enforcer, comprising:
a processing circuit configured to:
receive a control signal representing a target rate that is based on at least one load measure of a radio cell obtained from a scheduler;
enforce the target rate between a data source and a data destination over a shared radio link in the radio cell.

42. A data source network node, comprising:
a rate enforcer comprising a processing circuit configured to:
receive a control signal representing a target rate that is based on at least one load measure of a radio cell obtained from a scheduler;
enforce the target rate between a data source and a data destination over a shared radio link in the radio cell.

43. The data source network node of claim 42, wherein the data source network node is a User Equipment.

44. The data source network node of claim 42, wherein the data source network node is a computer.

45. A network assisted rate adaptor, comprising:
a rate controller circuit configured to determine a target rate based on at least one load measure of a radio cell obtained from a scheduler;
a rate enforcer circuit configured to enforce the target rate between a data source and a data destination over a shared radio link in the radio cell.

46. A base station, comprising:
a network assisted rate adaptor, the rate adaptor comprising:
a rate controller circuit configured to determine a target rate based on at least one load measure of a radio cell obtained from a scheduler;
a rate enforcer circuit configured to enforce the target rate between a data source and a data destination over a shared radio link in the radio cell.

47. A computer program product stored in a non-transitory computer readable medium for controlling rate estimation, the computer program product comprising software instructions which, when run on a processing circuit of a computer, causes the computer to determine a target rate based on at least one load measure of a radio cell obtained from a scheduler.
